(19) United States
(12) Patent Application Publication
(10) Pub. No.: US 2023/0307787 A1
(43) Pub. Date: Sep. 28, 2023

(54) Single-Layer Separator for Secondary Battery and Secondary Battery Including the Same

(71) Applicant: SK On Co., Ltd., Seoul (KR)

(72) Inventors: Yun Kyung Jo, Daejeon (KR); Soo Im Goo, Daejeon (KR); Jeong Han Kim, Daejeon (KR); Whee Sung Kim, Daejeon (KR)

(21) Appl. No.: 18/114,319

(22) Filed: Feb. 27, 2023

(30) Foreign Application Priority Data
Feb. 28, 2022 (KR) 10-2022-0026378

(51) Int. Cl. H01M 50/423; H01M 50/446; H01M 50/42; H01M 50/489

(52) U.S. Cl. CPC H01M 50/423; H01M 50/42; H01M 50/446; H01M 50/489

(57) ABSTRACT

The present disclosure includes a single-layer separator for a secondary battery including 60 to 80 wt% of porous aramid substrate, 17 to 30 wt% of inorganic matter, and 3 to 10 wt% of organic binder based on a total weight of the separator. The inorganic matter and the organic binder are impregnated into a pore of the porous aramid substrate.

### CROSS-REFERENCE TO RELATED APPLICATION

This application claims priority to Korean Patent Application No. 10-2022-0026378 filed Feb. 28, 2022, the disclosure of which is hereby incorporated by reference in its entirety.

### BACKGROUND OF THE INVENTION

### 1. Field of the Invention

The present disclosure relates to a single-layer separator for a secondary battery and a secondary battery including the same.

### 2. Description of Related Art

A lithium secondary battery, which has high energy density and is easy to carry, is mainly used as a driving power supply for mobile information terminals such as a mobile phone, a laptop computer, and a smartphone. In addition, recently, research into using a lithium secondary battery as a driving power supply or a power storage power supply for a hybrid vehicle or an electric vehicle by using high energy density characteristics has been actively conducted. When the secondary battery is used in such medium or large-sized devices, a large number of secondary batteries may be electrically connected to increase capacity and output.

One of the main research issues in such a lithium secondary battery is to improve the stability of the secondary battery. In particular, when a thermal runaway phenomenon occurs due to heat generated by the decomposition reaction of an active material, an excessive current may occur due to damage to a separator, short circuit of a cathode and an anode, and an internal short circuit, which may cause thermal runaway of the entire battery pack.

Therefore, as a method of improving safety of a secondary battery, there is a need to develop a separator having high strength and high heat resistance.

### SUMMARY OF THE INVENTION

An aspect of the present disclosure may provide a single-layer separator for a secondary battery having high mechanical strength and which does not cause a micro internal short circuit during battery charging.

Another aspect of the present disclosure may provide a secondary battery having excellent state of health (SOH) characteristics and improved stability.

According to an aspect of the present disclosure, a single-layer separator for a secondary battery may include 60 to 80 wt% of porous aramid substrate, 17 to 30 wt% of inorganic matter, and 3 to 10 wt% of organic binder based on a total weight of the separator, in which the inorganic matter and the organic binder are impregnated into a pore of the porous aramid substrate.

According to another aspect of the present disclosure, a secondary battery may include a cathode, an anode, and a single-layer separator for a secondary battery.

### DESCRIPTION OF THE INVENTION

Hereinafter, exemplary embodiments of the present disclosure will be described. However, exemplary embodiments in the present disclosure may be modified in several other forms, and the scope of the present disclosure is not limited to exemplary embodiments to be described below.

According to an aspect of the present disclosure, there is provided a single-layer separator for a secondary battery including 60 to 80 wt% of porous aramid substrate, 17 to 30 wt% of inorganic matter, and 3 to 10 wt% of organic binder based on a total weight of the separator, in which the inorganic matter and the organic binder are impregnated into a pore of the porous aramid substrate.

In the present disclosure, the porous aramid substrate may be meta-aramid, para-aramid, or a mixture thereof. The substrate may be a non-woven fabric substrate, and the non-woven fabric substrate may be manufactured by a method known in the art.

For example, the non-woven fabric substrate may be manufactured by a wet non-woven fabric manufacturing method using a para-aramid raw material synthesized using a strong acid, or by electrospinning a spinning solution in which meta-aramid is dissolved in an organic solvent. Examples of the organic solvents that may be used in the preparation of the meta-aramid include, but are not limited to, dimethylformamide (DMF), dimethylacetamide (DMAc), and the like. In addition, the non-woven fabric substrate manufacturing process may include refining, sheeting, dehydration and drying processes of raw materials.

The porous aramid substrate has a significantly higher breaking temperature due to heat than that of a polyethylene or polypropylene separator due to high heat resistance which is a characteristic of the raw material itself. However, large pores may occur inside the aramid substrate in the nonwoven fabric manufacturing process, and when such an aramid substrate is applied to the battery as it is without any additional treatment, micro internal short circuits due to the large pores may cause a leakage current during battery charging.

The present disclosure is intended to prevent the leakage current from occurring during the battery charging by impregnating inorganic matter and an organic binder into pores of the porous aramid substrate having high heat resistance.

The inorganic matter may be at least one selected from the group consisting of aluminum hydroxide (Al (OH)₃), magnesium hydroxide (Mg(OH)₂), aluminum oxide (Al₂O₃), magnesium oxide (MgO), calcium oxide (CaO), barium sulfate (BaSO₄), boehmite, titanium dioxide (TiO₂), silica (SiO₂), and clay, but is not limited thereto.

The inorganic matter may have an average particle diameter of 40 nm or more, preferably 80 nm or more, more preferably 100 nm or more, and 1.6 µm or less, preferably 0.7 µm or less, and more preferably 160 nm or less. When the average particle diameter is less than 40 nm, it may be difficult to uniformly distribute the inorganic matter within the separator, and when the average particle diameter exceeds 1.6 µm, it may adversely affect the uniformity of the surface and the thickness uniformity of the separator, which is not preferable.

Meanwhile, the organic binder is used to fix inorganic matter, or inorganic matter and an aramid substrate, and may be at least one selected from the group consisting of, for example, polyvinylpyrrolidone, polyacrylonitrile, and polymethyl methacrylate, but is not limited thereto.

The separator according to the present disclosure may include 60 wt% or more, preferably 65 wt% or more, and 80 wt% or less, preferably 70 wt% or less of the porous aramid substrate based on the total weight of the separator. In addition, the inorganic matter may be included in an amount of 17 wt% or more and 30 wt% or less. In addition, the organic binder may be included in an amount of 3 wt% or more and 10 wt% or less. When the content of the inorganic matter is too high compared to the porous aramid substrate, it is difficult to secure appropriate strength due to the insufficient content of the porous aramid substrate, which shows high strength characteristics, so the separator may be damaged during the battery assembly.

When the content of the organic binder is too large compared to the porous aramid substrate, the excessive amount of organic binder may aggregate on the surface of the substrate, and the aggregated organic binder may prevent inorganic matter from penetrating into the porous aramid substrate. Accordingly, the deterioration in the battery stability and the battery state of health may occur.

Meanwhile, when the content of the inorganic matter or the content of the organic binder is insufficient compared to the porous aramid substrate, battery stability may deteriorate since a micro internal short circuit may occur due to the pores of the substrate.

The separator according to the present disclosure may be prepared by impregnating the inorganic matter and the organic binder into the porous aramid substrate. The impregnation method is not particularly limited, and for example, a dip-coating method may be used.

In this case, the organic binder may be dispersed in acetone, methylene chloride, chloroform, dimethylformamide, N-methyl-2-pyrolidone (NMP), or a mixture thereof. That is, the porous aramid substrate and the inorganic matter may be put into a solvent in which the organic binder is dispersed and left for a certain period of time to manufacture the separator in which the inorganic matter and the organic binder are impregnated into the pores of the substrate.

The separator according to the present disclosure is a single-layer separator that does not include a porous substrate such as polyethylene or polypropylene in addition to the porous aramid substrate described above, and may be thinned, so separator having a thickness applicable to automobile batteries may be manufactured.

The separator may have a thickness of 10 µm or more, preferably 12 µm or more, more preferably 13 µm or more, and may also have a thickness of 17 µm or less, preferably 15 µm or less. When the thickness is less than 10 µm, the separator is easily torn in the battery manufacturing process due to excessively low mechanical strength, and thus, the battery manufacturing does not proceed smoothly, and when the thickness exceeds 17 µm, a thickness proportion occupied by the separator within the limited size of the battery increases, and thus, the target energy density of the battery may not be expressed, which is not preferable.

In addition, the separator may have an air permeability of 30 sec/100 cc or more, preferably 40 sec/100 cc or more, more preferably 50 sec/100 cc or more, and may also have an air permeability of 100 sec/100cc or less, preferably 80 sec/100 cc or less, more preferably 60 sec/100 cc or less. As such, the separator according to the present disclosure shows significantly lower air permeability compared to the separator in which the inorganic matter and the organic binder are not impregnated into pores.

The separator according to the present disclosure may be applied to the secondary battery. The secondary battery may include a cathode; an anode; the above-mentioned separator. In this case, the cathode and the anode are not particularly limited as long as they are known in the art.

### EXAMPLES

Hereinafter, embodiments of the present disclosure will be described in detail. The following examples are only for understanding of the present disclosure, but do not limit the present disclosure.

### Examples 1 to 4 and Comparative Examples 1 to 3

### Manufacture of Separator

A separator was manufactured by impregnating aluminum oxide (Al₂O₃) and polyacrylonitrile dispersed in an acetone solvent into porous aramid nonwoven fabric using a dip-coating method. The contents of an aramid substrate, aluminum oxide, and an organic binder based on the total weight of the manufactured separator were shown in Table 1 below.

### Manufacture of Cathode

94 wt% of LiCoO₂ as a cathode active material, 2.5 wt% of polyvinylidene fluoride as an adhesive, 3.5 wt% of Super-P (Imerys) as a conductive material were added to N-methyl-2- pyrrolidone (NMP) which is an organic solvent and stirred to prepare a uniform cathode slurry. The slurry was coated on a 30 µm thick aluminum foil, dried at a temperature of 120° C., and then pressed to prepare a cathode plate having a thickness of 150 µm.

### Manufacture of Anode

95 wt% of artificial graphite as an anode active material, 3 wt% of acrylic latex (BM900B, solid content 20 wt%) with T_{g} of –52° C. as an adhesive, 2 wt% of carboxymethyl cellulose (CMC) as a thickener were added to water as a solvent and stirred to prepare a uniform anode slurry. The slurry was coated on a 20 µm thick copper foil, dried at a temperature of 120° C., and then pressed to prepare a cathode plate having a thickness of 150 µm.

### Manufacture of Secondary Battery

A pouch-type battery was assembled in a stacking method using the manufactured cathode, anode, and separator. The lithium secondary battery was manufactured by injecting an electrolytic solution having ethylene carbonate (EC) /ethyl methyl carbonate (EMC) /dimethyl carbonate (DMC) = 3: 5: 2 (volume ratio) in which 1 M of lithium hexafluorophosphate (LiPF₆) is dissolved into each of the assembled batteries.

TABLE 1

| | Composition of separator [wt%] | | | Average particle diameter of inorganic matter [nm] | Thickness of separator [µm] |
|---|---|---|---|---|---|
| | Aramid substrate | Inorganic matter | Organic binder | | |
| Example 1 | 60 | 35 | 5 | 160 | 17 |
| Example 2 | 60 | 30 | 10 | 100 | 12 |
| Example 3 | 80 | 17 | 3 | 40 | 12 |
| Example 4 | 80 | 17 | 3 | 1600 | 17 |
| Comparative Example 1 | 50 | 40 | 10 | 40 | 17 |
| Comparative Example 2 | 90 | 8 | 2 | 160 | 17 |
| Comparative Example 3 | 60 | 25 | 15 | 100 | 17 |
| Comparative Example 4 | 60 | 35 | 5 | 160 | 9.5 |
| Comparative Example 5 | 60 | 30 | 10 | 100 | 23 |
| Comparative Example 6 | 80 | 17 | 3 | 30 | 12 |
| Comparative Example 7 | 50 | 40 | 10 | 2000 | 17 |

### Physical Property Evaluation Method

According to the physical property evaluation method below, the physical properties of the separators and batteries manufactured in Examples and Comparative Examples were evaluated, and the results are shown in Table 2.

### 1. Air Permeability

The air permeability is measured using EG01-55R-1MR equipment of Asahi Seiki Corp. Measurements are made on 5 or more samples, and the average value is taken as a representative value.

### 2. State of Separator During Stack Assembly

Stacking is carried out by crossing the cathode and the separator anode using automatic equipment. After the stack is completed, the entire separator in the stack including the cathode, the separator, and the anode must not be torn and need not be combined.

### 3. SOH at Room Temperature

Under 25° C., a cycle test in the range of 2.89 V to 4.115 V is performed under 1 C conditions, and the number of cycles at which the remaining state of health (SOH) reaches 70% of the initial capacity is confirmed.

### 4. Nail Penetration

After each of the batteries manufactured in Examples and Comparative Examples is fully charged to 100% state of charge (SOC), nail penetration evaluation is performed. In this case, a diameter of the nail is 3.0 mm, and a penetration speed of the nail is fixed at 80 mm/min.

It is determined as “normal” when no explosion or ignition phenomenon occurs, “ignition” when the explosion or ignition occurs, and “no evaluation” when evaluation cannot be performed since the appropriate form of battery assembly is not performed.

### 5. Heat Exposure

The batteries are stored in an adiabatic chamber and the temperature of the chamber is raised at 5° C. per minute to reach 140° C. The state of the battery is observed for 1 hour.

TABLE 2

| | Air permeability of separator [sec/100 cc] | State of separator during stack assembly | SOH at room temperature [Times] (Number of cycles to SOH70%) | Nail penetration | Heat exposure (140° C., 1 hour) |
|---|---|---|---|---|---|
| Example 1 | 30 | Good | 1300 | Normal | Normal |
| Example 2 | 40 | Good | 1300 | Normal | Normal |
| Example 3 | 30 | Good | 1300 | Normal | Normal |
| Example 4 | 35 | Good | 1300 | Normal | Normal |
| Comparative Example 1 | 25 | Bad | No evaluation | No evaluation | No evaluation |
| Comparative Example 2 | 40 | Good | 700 | Ignition | Ignition |
| Comparative Example 3 | 60 | Good | 700 | Ignition | Ignition |
| Comparative | 20 | Bad | No | No | No |
| Example 4 | | | evaluation | evaluation | evaluation |
| Comparative Example 5 | 40 | Good | Insufficient energy density – not evaluated | Normal | Normal |
| Comparative Example 6 | 40 | Good | 700 | Ignition | Ignition |
| Comparative Example 7 | 30 | Bad | 700 | Normal | Normal |

Referring to Table 2, the separators of Examples 1 to 4 according to the present disclosure showed good separator conditions during stack assembly, and showed excellent battery SOH, and showed excellent results in the evaluation of nail penetration and heat exposure. On the other hand, the separator of Comparative Example 1 containing an excessive amount of inorganic matter compared to the aramid substrate was unable to normally assemble a battery due to lack of strength, and thus, the battery SOH, nail penetration characteristics, and heat exposure characteristics could not be evaluated.

The separator of Comparative Example 2, which has the insufficient contents of the inorganic matter and the organic binder compared to the aramid substrate, was ignited during the nail penetration and heat exposure evaluation due to the micro short circuit inside the battery, and the long SOH characteristics of the battery also showed poor results.

The separator of Comparative Example 3 containing the excessive amount of organic binder compared to the aramid substrate was also ignited during the nail penetration and heat exposure evaluation, and the long SOH characteristics of the battery also showed poor results. As a result, it can be seen that the excessive amount of organic binder is aggregated on the surface of the substrate to prevent the inorganic matter from penetrating into the pores of the aramid substrate.

The battery could not be normally assembled due to the insufficient thickness of the separator of Comparative Example 4, and thus, the battery SOH, the nail penetration characteristics, and the heat exposure characteristics could not be evaluated. In Comparative Example 5, the thickness of the separator was too thick, and the SOH at room temperature could not be measured due to the insufficient energy density.

In Comparative Example 6, the average particle diameter of the inorganic matter was too small, so the ignition occurred during the nail penetration and heat exposure evaluation due to the micro short circuit inside the battery, and the long SOH characteristics of the battery also showed poor results. On the other hand, in Comparative Example 7, the average particle diameter of the inorganic matter was too large, so the battery could not be assembled.

As set forth above, according to an exemplary embodiment in the present disclosure, there may be provided the single-layer separator for a secondary battery having high strength and high heat resistance and do not cause a micro internal short circuit during battery charging by impregnating inorganic matter and organic binders into porous aramid pores.

In addition, according to an exemplary embodiment in the present disclosure, there may be provided the secondary battery having excellent state of health characteristics and improved stability by applying the single-layer separator.

While exemplary embodiments have been shown and described above, it will be apparent to those skilled in the art that modifications and variations could be made without departing from the scope of the present invention as defined by the appended claims.

What is claimed is:

1. A single-layer separator for a secondary battery, comprising:
60 to 80 wt% of porous aramid substrate, 17 to 30 wt% of inorganic matter, and 3 to 10 wt% of organic binder based on a total weight of the separator,
wherein the inorganic matter and the organic binder are impregnated into a pore of the porous aramid substrate.

2. The single-layer separator of claim 1, wherein the porous aramid substrate is meta-aramid, para-aramid, or a mixture thereof.

3. The single-layer separator of claim 1, wherein the inorganic matter is at least one selected from the group consisting of aluminum hydroxide (Al(OH)₃), magnesium hydroxide (Mg(OH)₂), aluminum oxide (Al₂O₃), magnesium oxide (MgO), calcium oxide (CaO), barium sulfate (BaSO₄), boehmite, titanium dioxide (TiO₂), silica (SiO₂), and clay.

4. The single-layer separator of claim 1, wherein an average particle diameter of the inorganic matter is 40 nm to 1.6 µm.

5. The single-layer separator of claim 1, wherein the organic binder is at least one selected from the group consisting of polyvinylpyrrolidone, polyacrylonitrile, and polymethylmethacrylate.

6. The single-layer separator of claim 1, wherein a thickness of the separator is 10 to 17 µm.

7. The single-layer separator of claim 1, wherein an air permeability of the separator is 30 to 100 sec/100 cc.

8. A secondary battery, comprising:
a cathode;
an anode; and
a single-layer separator for a secondary battery,
wherein the separator includes 60 to 80 wt% of porous aramid substrate, 17 to 30 wt% of inorganic matter, and 3 to 10 wt% of organic binder based on a total weight of the separator, and
the inorganic matter and the organic binder are impregnated into a pore of the porous aramid substrate.

9. The secondary battery of claim 8, wherein the porous aramid substrate is meta-aramid, para-aramid, or a mixture thereof.

10. The secondary battery of claim 9, wherein the inorganic matter is at least one selected from the group consisting of aluminum hydroxide (Al(OH)₃), magnesium hydroxide (Mg(OH)₂), aluminum oxide (Al₂O₃), magnesium oxide (MgO), calcium oxide (CaO), barium sulfate (BaSO₄), boehmite, titanium dioxide (TiO₂), silica (SiO₂), and clay.

11. The secondary battery of claim 9, wherein an average particle diameter of the inorganic matter is 40 nm to 1.6 µm.

12. The secondary battery of claim 9, wherein the organic binder is at least one selected from the group consisting of polyvinylpyrrolidone, polyacrylonitrile, and polymethylmethacrylate.

13. The secondary battery of claim 9, wherein a thickness of the separator is 10 to 17 µm.

14. The secondary battery of claim 9, wherein an air permeability of the separator is 30 to 100 sec/100 cc.
